(19) United States
(12) Patent Application Publication
(10) Pub. No.: US 2025/0377472 A1
(43) Pub. Date: Dec. 11, 2025

(54) Low Fluid Pressure Stimulation of Seismic Emissions from Permeable Fractures

(71) Applicant: ENEGIS, LLC, Fairfax, VA (US)

(72) Inventors: Peter A. GEISER, Lyons, CO (US); Peter Eric MALIN, Lyons, CO (US); Jeffrey F. EPPINK, Fairfax, VA (US)

(21) Appl. No.: 19/219,731

(22) Filed: May 27, 2025

Related U.S. Application Data
(60) Provisional application No. 63/652,552, filed on May 28, 2024.

(51) Int. Cl. G01V 1/34; G01V 1/28; G01V 1/30

(52) U.S. Cl. CPC G01V 1/345; G01V 1/282; G01V 1/301

(57) ABSTRACT

Provided herein is low fluid pressure stimulation of seismic emissions from permeable fractures. The low fluid pressure is selected to ensure the resultant stimulated seismic emissions are of a small amplitude such that no new fractures open up in the fluid reservoir that contains the relevant permeable fractures. The low fluid pressure stimulation of seismic emissions is used to image the permeable fracture network of the fluid reservoir. The image may then be used in a range of applications related to fluid injection and/or recovery, process improvement and the like.

### CROSS REFERENCE TO RELATED APPLICATIONS

This application claims the benefit of U.S. Provisional Patent Application No. 63/652,552 filed on May 28, 2024, which is incorporated by reference herein in its entirety.

### STATEMENT REGARDING FEDERALLY SPONSORED RESEARCH OR DEVELOPMENT

This invention was made with United States governmental support under Grant No. DE-AR0001660 awarded by the U.S. Department of Energy. The government has certain rights in the invention.

### FIELD OF INVENTION

Provided herein are methods for stimulating weak seismic emissions from permeable voids, fractures and fracture zones. The weak seismic emissions can be signal enhanced and used to map their origin points.

A critical requirement for successfully extracting fluid resources from the Earth's brittle crust is the direct mapping of the location of subsurface fluid flow channels and structures-specifically a connected permeable fracture network(s) comprising fractures, fracture zones, and other connected, fluid filled voids in rock. Moreover, for cost effective resource development, their locations need to be determined before committing to capital intensive drilling and to guide fluid injection and withdrawal activities. Achieving these goals require a method for causing these features to reveal them prior to drilling and during field development. We note that testing can be done most economically with a slim hole. The methods provided herein utilizes low fluid-pressure increases that are«fracture pressure (P_{frac}) (also referred herein as P_{crit}, and is the pressure required to open fractures and may be expressed in terms of lbs/in²) in near—by boreholes to stimulate small amplitude (e.g., “weak”) seismic emissions from permeable fractures and fracture zones.

These emissions can be recorded by signal enhancing networks of surface and/or near-surface seismic sensors networks (“seismic sensors”) and then processed by one-way-travel seismic migration methods to find the locations of connected permeable fracture network(s), thereby mitigating resource development risks. The combined, well-established, recording and processing techniques we refer together as ambient seismic Permeable Fracture Imaging (PFI). This work shows that PFI signals can be created by small pressure changes in boreholes hundreds of meters away from their originating fractures.

### BACKGROUND

The methods provided herein arise from observations of the mechanical-stress state of the Earth's crust and its hydromechanical stress-change response. We show that very small changes in stress give rise to weak seismic signals that can be recorded by multiple station geophone networks. Combined with well-established seismic reflection and refraction signal processing technology, the instant methods supersedes the current use of microearthquake (MEQ) monitoring for locating subsurface permeability (e.g., the current method that is commonly called microseismics).

An important early finding on the mechanical-failure sensitivity of the brittle crust was presented by Ziv and Rubin (2000). Using a simple continuum mechanics model of earthquake triggering by local stress changes, they hypothesized that seismic dislocations could be initiated by local deviatoric stress changes as small as 0.1 psi—e.g. a net force of 1000 lbs distributed over a 10,000 in² asperity.

Extensive research since then has established that most of the brittle crust is close to mechanical failure along fractures, fracture zones, and faults (e.g. Leary 2007). As a result of this geocritical state small changes in the crust's stress field result in slips and openings along these structures as well as resonating waves along the contact between the fracture surface and fracture fluid. This failure process is mediated by fluids within these structures, with fluid movements responding to, and interacting with, the surrounding rock. Numerical models (e.g. Frehner 2014) and field observations (e.g. Geiser et al, 2023) of this coupled rock-fluid system show that it emits weak but detectable seismic signals that can be observed at the earth's near-surface using passive seismic recording networks (Sicking and Malin, 2019).

Our work with PFI has revealed that the natural stress field of the Earth's brittle crust is a composite of two separate stress fields that we call the long lasting Tectonic and the shorter time-scale Transient stress fields. The Tectonic stress is controlled by large scale Plate motions while the Transient is the product of natural local loadings such as air mass movement, oceanic wave activity, teleseismic, local, and microearthquakes, and other short term earth movements and tidal forces. The two natural fields are nearly continuously active and form a composite field. Small, episodic, changes in this composite field can induce PFI source signals. These signals can be detected, recorded, and enhanced by the signal processing methods mentioned above, allowing their associated permeable fractures to be located.

Our passive seismic studies have also shown that temporary stress fields induced by human activity can create PFI signals (e.g., hydraulic fracture stimulation.) This type of activity is typically associated with the extraction or injection of fluid. We call this the Induced stress field. The net stress field is a composite of all three fields, but the Induced component is only present when there is the appropriate human activity. While the rate of natural loadings may be on the order of ˜10⁻¹⁸ to 10⁻⁶/see we find that the elastic responses of the crust as indicated by variation in the signal processing method known as semblance value occur at the second time scale suggesting that there is continual natural composite flux of multiple different interfering stress loadings producing currently measurable responses. In contrast, human loadings which are large and continuous relative to the flux of natural loadings may range from instantaneous (explosions) to constant for a time of hours, e.g., hydraulic stimulation at P_{frac}.

The three independent stress fields described above can be defined by the same three properties: 1. Stress magnitude; 2. Stress orientation; 3. Rate of change of principal stress (see, e.g., Table 1).

TABLE 1
Summary of the three independent stress fields:

| | | Energy | |
|---|---|---|---|
| | Orientation | Magnitude | Rate of change |
| Tectonic | Fixed by Plate | Fixed by plate | Smaller <<10⁻⁶/sec |
| Stress | motions | motions | Rate of plate motion |
| Field | | | changes |
| Transient | Controlled by | Controlled by | Real time Composite stress |
| Stress | variable | different types | field of natural loading |
| Field | loadings. | of natural local | and Tectonic stresses. |
| | | loading | |
| Induced | Controlled by | Controlled by | Real time composite stress |
| Stress | variable | size of | field of tectonic, natural |
| Field | loadings due | industrial and | and human induced loading |
| | to human | other kinds | changes >>10⁻⁶/sec |
| | activity | of human | |
| | | activity | |

The first method proposed for the use of Seismic Emission Tomography to map permeable, fluid-filled fractures and fracture zones due to fluid pressure changes is that of Geiser 2006 (U.S. Pat. No. 7,127,353). That method is based on observations of fluid pressure induced earthquake activity at the Rangely field in central Colorado (Raleigh et al, 1976) and the Rate Correlation studies of Hefer et al (1997). Geiser (2002), by combining the results of the latter two studies, showed that if the direction of the maximum horizontal stress is known, part of the subsurface permeability structure could be mapped by MEQ monitoring.

Initially, because the work of Raleigh et al. and Hefer et al. involved injecting fluids with borehole over-pressures of more than 1500 psi it was thought that MEQ-based permeability mapping required high, hydraulic-fracture-magnitude injection pressures: as much or more than 10,000 psi. Subsequent work in 2003 in the Barnett Shale (Geiser et al, 2006) and monitoring water inflows in a potash mine (Geiser et al, 2023) revealed the low pressure seismic activation of permeability networks.

Further, using PFI data, Geiser et al, (2006, 2023) showed that MEQs can only image a limited portion of the permeability field. There are two reasons for this realization:
1. Permeable Fracture size distribution: Fracture sizes follow a log normal distribution such that most fractures have dimensions far below the threshold of standard methods for detecting MEQ-producing slips.
2. Permeable Fracture spatial distribution: Geiser (U.S. Pat. No. 6,389,361) discusses how injection fluid pressures sufficient to induce MEQs implicitly assumes that permeability is limited to their epicentral location. This results in the following assumptions about the spatial properties of permeability and the method needed to create the MEQs that reveal its location:
   a. Permeability is located in two opposing conical volumes with apical angles ranging from 30° to 45°;
   b. The cone axes parallel SHmax;
   c. the MEQ inducing injection point formed the location of the two opposed conical volumes.

Instead, as noted by Geiser et al (2023), further work revealed that the spatial distribution of the permeable structure follows the heterogeneous power law distribution described by, for example, by Malin et al (2020). This distribution is much more complex and spatially distributed than the intersecting, MEQ-defined, conical volume assumption discussed by Geiser (U.S. Pat. No. 6,389,361).

The methods herein for Low Fluid Pressure Stimulation of Seismic Emissions from Permeable Fractures show that the use of MEQs for mapping permeability is of very limited use as it only provides scattered fracture locations which may or may not be part of the permeability architecture. Thus, the MEQ method leaves out the most important part of the subsurface permeability, the volumetric distribution of connected permeable fracture network(s).

Further, consistent with the work of Ziv and Rubin (2000), the methods herein show that bottom hole pressures of 0.1 psi are sufficient to stimulate PFI signals, even at several hundred meters or more from the fluid injection point. As a result, the methods provided herein substantially reduces costs and hazards by eliminating the need for heavy high-pressure injection equipment and attendant risk of damaging inducted earthquakes. Importantly, the PFI techniques provided herein can mitigate uncertainty for geothermal exploration, development and reservoir monitoring as it provides a less costly, more comprehensive, and less risky tool for locating connected permeable fracture network(s).

### SUMMARY

The claims provided herein are specifically incorporated by reference. For example, provided are methods of imaging a connected permeable fracture network, including that of a fluid reservoir in rock (e.g., the Earth's brittle crust). The method may comprise the steps of: establishing a network of seismic sensors centered around at least one fluid injection site in the fluid reservoir for detecting small-amplitude seismic emissions. A fluid is injected into the at least one fluid injection site, such as a bore hole or the like. The fluid is injected in a manner to cause a fluid pressure wave to be generated in the fluid reservoir and an increase in fluid pressure in the fluid injection site, wherein the increase in pressure is less than a fracture pressure (P_{frac}). P_{frac} is a pressure required to induce a new permeable fracture in the connected permeable fracture network and cause a fluid loss from a wellbore into at least one of the induced new permeable fractures. In contrast, below P_{frac}, no new permeable fractures are opened so that there is no significant or measureable fluid loss into an induced new permeable fracture. The increase the increase in fluid pressure may also be described quantitatively, such as greater than 0 and less than 10 MPa, so long as it is selected to produce an instantaneous elastic deformation of the rock and stimulate a small-amplitude seismic emissions from the connected permeable fracture network without an earthquake(s) detectable with a surface seismic station associated with the at least one injection site. This reflects that the increase in fluid pressure is insufficient to induce a new permeable fracture. The seismic emission is acquired with the network of seismic sensors and attendant imaging with the network of seismic sensors of an at least one volume of the instantaneous elastic deformation comprising the connected permeable fracture network and the at least one fluid injection site. The at least one volume image comprises a temporal migration of the small-amplitude seismic emissions away from the at least one injection site. From the image of the at least one volume a connected permeable fracture(s) is identified that forms the connected permeable fracture network to which the at least one injection site is connected. In this manner, the connected permeable fracture network of the fluid reservoir is imaged.

The image may be used in a number of useful applications, ranging from wellbore location and guided injections/withdrawals; multidimensional analysis of properties of the connected permeable fracture network; improving a process related to connected permeable fracture networks.

Provided herein are: (1) methods of imaging a connected permeable fracture network of a fluid reservoir in rock, the method comprising the steps of: establishing a network of seismic sensors centered around at least one fluid injection site in said fluid reservoir for detecting small-amplitude seismic emissions; injecting a fluid into the at least one fluid injection site, causing a fluid pressure wave to be generated in said fluid reservoir and an increase in fluid pressure in the fluid injection site, wherein the increase in pressure is less than a fracture pressure (P_{frac}), and P_{frac} is a pressure required to induce a new permeable fracture in the connected permeable fracture network and cause a fluid loss from a wellbore into at least one of the induced new permeable fractures; wherein the increase in fluid pressure is greater than 0 and less than 10 MPa and selected to produce an instantaneous elastic deformation of the rock and stimulate a small-amplitude seismic emissions from the connected permeable fracture network without an earthquake(s) detectable with a surface seismic station associated with said at least one injection site, acquiring the seismic emission with the network of seismic sensors; imaging with the network of seismic sensors and at least one volume of the instantaneous elastic deformation comprising the connected permeable fracture network and the at least one fluid injection site, wherein the at least one volume image comprises a temporal migration of the small-amplitude seismic emissions away from said at least one injection site; identifying from said image of the at least one volume a connected permeable fracture(s) that form said connected permeable fracture network to which said at least one injection site is connected, thereby imaging said connected permeable fracture network of said fluid reservoir.
(2) Also provided is the method of embodiment (1), wherein the increase in pressure corresponds to a fluid pressure in the at least one fluid injection site that is a well borehole and that does not form a plurality of new permeable fractures in the connected fracture network.
(3) Also provided is the method of any one of embodiments (1)-(2), further comprising the step of determining the increase in pressure by: increasing the pressure from a minimal pressure and incrementally increasing the minimal pressure until the connected permeable fracture network is stimulated.
(4) Also provided is the method of any one of embodiments (1)-(3), further comprising the step of using the imaged connected permeable fracture network to: position a well borehole; and/or guide injection and withdrawal activities.
(5) Also provided is the method of any one of embodiments (1)-(4), further comprising the step of: using the image of the at least one volume as an input to a model of said fluid reservoir.
(6) Also provided is the method of any one of embodiments (1)-(5), further comprising the step of: using the image of the at least one volume to position additional well boreholes.
(7) Also provided is the method of embodiment (6), wherein the additional well boreholes are used for infill, development, and/or enhanced recovery of a liquid from the fluid reservoir.
(8) Also provided is the method of any one of embodiments (1)-(7), further comprising the step of: using the image of the at least one volume to perform a multidimensional analysis of a permeable fracture property of said connected permeable fracture network.
(9) Also provided is the method of embodiment 8, wherein said permeable fracture property comprises one or more petrophysical properties.
(10) Also provided is the method of any one of embodiments (8)-(9), wherein said multidimensional analysis includes direct time lapse 3D seismic (x,y,z) and 4D seismic (x,y,z,t; where t is calendar time and x, y and z spatial co-ordinates) measurements of components of said connected fracture network over a time period.
(11) Also provided is a method of any one of embodiments (1)-(10), the method further comprising: using the image of the at least one volume to improve a process, wherein the process is optionally selected from one or more of: reservoir model, a tiltmeter survey model, a fluid motion model, and/or a hazard model associated with fluid extraction and injection into and out of native rock.
(12) Also provided is a method of embodiment (11), wherein the step of using the image of the at least one volume to improve said process comprises using the image of the at least one volume to improve a velocity model.
(13) Also provided is a method of any one of embodiments (11)-(12), wherein the step of using the image of the at least one volume to improve said process comprises using the image of the at least one volume to improve interpretation of a geophysical survey.
(14) Also provided is a method of embodiment (13), further comprising the step of: identifying subsurface behavior of the Earth's crust associated with fluid motion.
(15) Also provided is a method of any one of embodiments (11)-(14), wherein using the image of the at least one volume to improve said process comprises using the image of the at least one volume to confirm paths of fluid motion.
(16) Also provided is a method of any one of embodiments 11-15, wherein using the image of the at least one volume to improve said process comprises using the image of the at least one volume to identify and assess risk of possible hazards from deformation of the Earth's crust associated with fluid injection and fluid extraction, the hazard including damage to human infrastructure.
(17) Also provided is a method of any one of embodiments (1)-(16), wherein the imaging comprises identifying and mapping a location of one or more of: a permeable fracture; a permeable fracture network; and/or an interconnected fluid filled void in native rock.
(18) Also provided is a method of embodiment (17), wherein the imaging is prior to a step of drilling a well borehole and/or guiding fluid injection and fluid recovery from the fluid reservoir.
(19) Also provided is a method of any one of embodiments (1)-(18), wherein the increase in fluid pressure occurs in one or more pre-existing boreholes positioned within the fluid reservoir.
(20) Also provided is a method of any one of embodiments (1)-(19), wherein the network of seismic sensors comprise near and/or near-surface seismic arrays.

### BRIEF DESCRIPTION OF THE DRAWINGS

FIG. 1: Photographs showing a (Top left panel): Water tank truck and lower pressure-high volume pump for filling borehole 55-29 to surface. (Top right panel): Higher pressure-lower volume pressure washer pump for boosting wellhead pressure. (Lower left panel): Well 55-29 wellhead completion. The pressure gauge used to obtain the coarse readings is on the plywood floor to the lower left of the wellhead. (Lower right panel): The pressure gauge used to obtain the fine readings shown in Table 2.

FIG. 2: Comparison of PFI map slices. Left hand Pre-LP stimulation Transient state activity and right-hand post LP stimulation PFI map of Induced Transient stress field activity. The map slice is at 6,560 ft in the open hole section of 55-29. The major axis of the ellipse is along the 2,013 ft offset to the 1 psi dislocation threshold and minor axis is along the regional structure.

FIG. 3: Comparison of PFI map slices. Left hand pre-LP stimulation Transient State activity, PFI map; right hand PFI map showing post-LP stimulation Induced Transient stress field activity. The map slice is at 6,890 ft (2,100m) in the open hole section of 55-29. The major axis of the ellipse is along the 2013 ft offset to the 1 psi dislocation threshold and minor axis is along the regional structure.

### DETAILED DESCRIPTION

As used herein, the term “permeable fracture network” refers to the permeability of a geologic formation such as a fluid reservoir in country rock. Permeability fracture networks can be represented by a three-dimensional image or a map based on a network of seismic sensors configured to detect small-amplitude seismic emissions. Accordingly, “rock” is used broadly herein to refer to that portion of the Earth in which the permeable fracture network resides.

“Small-amplitude seismic emissions” refers to a stress that is sufficiently small that new fractures in the permeable fracture network are not opened. Generally, the small-amplitude seismic emissions can refer to the seismic sensors detecting the emissions associated with a pressure wave in the fluid reservoir generated by a human increase in pressure less than the fracture pressure (P_{frac}). For example, the increase in pressure may be greater than 0 MPa and less than about 10 MPa, or any sub-ranges thereof. The absolute value is not particularly important as the fracture pressure will generally vary from fluid reservoir to fluid reservoir. Accordingly, the key aspect is ensuring the increase in pressure is less than P_{frac}, but rather ensuring the increase in pressure is less than P_{frac}. For example, the increased pressure may be less than P_{frac}; less than 0.9 P_{frac}; less than 0.5 P_{frac}; or less than 0.1 P_{frac}.

“Fluid reservoir” refers to a geologic formation containing one or more fluids embedded or trapped within the formation. Fluid reservoirs may have naturally occurring permeability and porosity. Fluid reservoirs may contain hydrocarbons or molecules comprising primarily hydrogen and carbon, but may contain other elements, for example, oxygen, nitrogen, and sulfur. Hydrocarbons may refer to fluids targeted for recovery and production common in the oil and gas industry, including oil, natural gas, condensate and the like, but also include more complex molecules, such as naturally occurring polymers and paraffins. Other relevant fluids include water.

### Example 1: Method of Low Pressure Stimulation of Permeable Fracture Imaging (LP-PFI) signals

A prior survey to locate an inflow site in a potash mine at a depth of 3,000 ft. suggested that PFI signals were stimulated by borehole-grouting pressure changes of several hundreds of psi—but less than 1500 psi (100 bars; Geiser et al, FIG. 6, 2023). This permeable-fracture seismic response was noticed as an incidental result in post field data collection signal processing. The methods provided herein, in contrast, are based on the outcome of a planned-in-advance test of that putative relationship.

The Newberry LP-PFI Stimulation experimental arrangement. We test the LP-PFI source stimulation hypothesis at the Newberry Crater in Oregon, in well 55-29. This existing well had been drilled to a depth of ˜10,000 ft (3,045 m) and left open below ˜6,450 ft (1970 m). A network of 977 geophones covering an area with a radius of 1.6 miles (2,600 m) centered on the well is used to observe the stimulation. This aperture allowed for high resolution PFI mapping to depth of ˜6890 ft (2100 m). The passive seismic PFI data from this network is collected from Julian day 286 to Julian day 290. The LP-PFI test is performed on Julian Day 289, between the hours of 1700 to 2030 UTC (1000 to 1330 PDT).

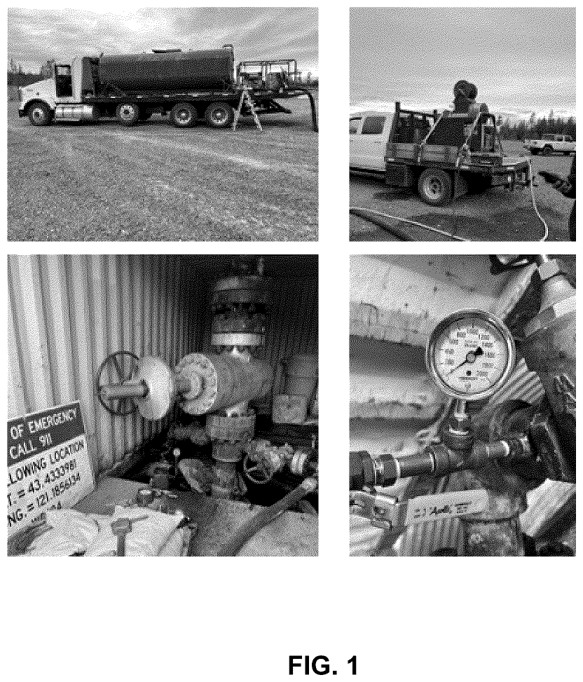

The test involves first filling the well from the water table to ground level with fresh water from a tanker-truck. Incremental wellhead-pressure is provided using a pressure-washer pump. Photos of the field set up are shown in FIG. 1, and pressure and pumping data are shown in Table 2. According to these data, it takes about 1300 gal to fill the well and, based the available 55-29 well schematic, this added a water column head of 435 ft (133 m) and a hydraulic overpressure of about 188 psi. The pressure-washer pumps in an additional 780 gal, adding another about 115 psi for a total overpressure of about 303 psi. Only about 143 gal of this added volume flowed back in the about 15 min before the well was shut in.

Well 55-29 open hole line source for PFI. The ˜303 psi (20.9 bar) over pressure produced by the filling and pressure-washer boost of well 55-29 was uniformly distributed along the open hole section below ˜6,450 ft (1970 m). Below this depth the open well can be approximately treated as line source, producing both volumetric compression and a Poisson-ratio-related tangential shear strain. Consequently, the over pressure decreases linearly with distance from the effective radius of 55-29.

The top of the open hole overlaps with the bottom of our PFI observation network's resolution at 6890 ft. The lithology of this overlapping section is a welded tuff, with a low density of significant pressure transferring fractures per foot of borehole-1 per ˜33 ft according to the standard well logs (Cladouhos et al., 2016). Using a 1-to-1 along-borehole-to-off-borehole relation, the effective radius of the over pressure transfer can be assumed to be on the same order: ˜33 ft (10 m).

Assuming also a published average Poisson ratio of 0.2 for the welded tuff and a simple linear relationship between stress and strain, an estimate of shear stress versus distance from 55-29 can be made. Using a Poisson ratio of 0.2 gives a shear stress of ˜61 psi (4.2 bars) at the effective overpressure boundary around the open hole section of 55-29. As discussed above, we take this boundary to be at 33 ft from 55-29. This is then the distance at which the linear line-source decreases from 61 psi (4.2 bars) begins. Using a conservative 1 psi drop in 33 ft threshold for triggering seismic generating dislocations equates to a stimulation off set of ˜2013 ft consistent with our observations.

As shown in the next section, this offset is consistent with the increased PFI activity observed by the seismic recording network at the Newberry Geothermal Field. Moreover, the 55-29 overpressure is a cylindrically symmetric line-source. Hence, the orientation of the triggered dislocations is primarily controlled by the background tectonic stress—in this case matching its NW-SE associated structural trend.

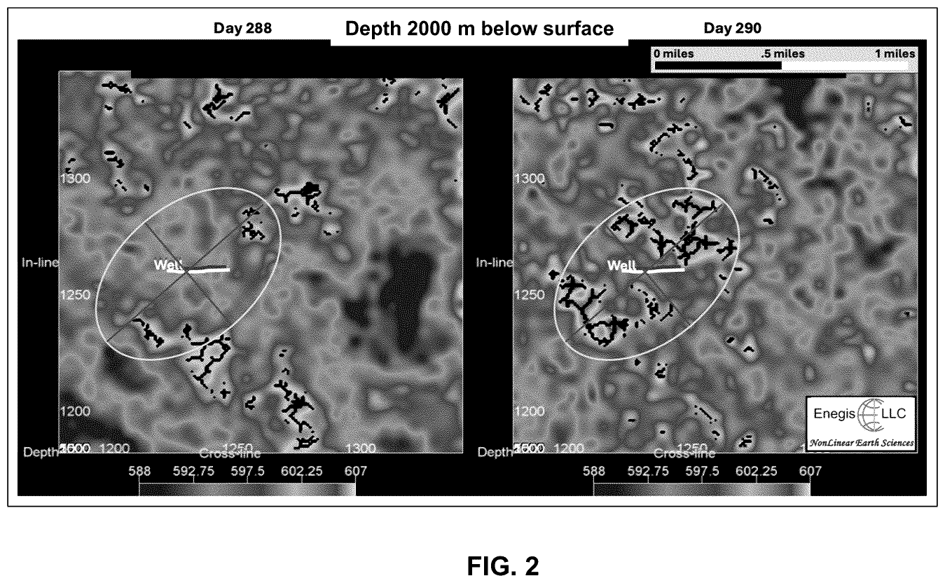

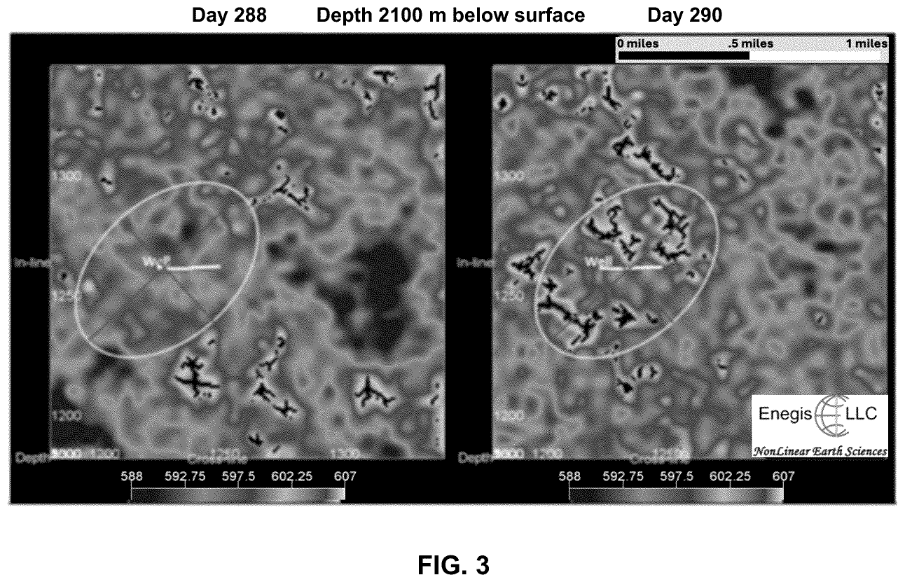

Evidence for low-pressure activation of PFI source emissions. FIGS. 2-3 show a comparison of the pre and post stimulation PFI maps at 6,560 ft and 6,890 ft. The Induced stress activated a group of PFI emission sources out to the distances found in the previous section. The orientation of these dislocations is also consistent with the structural grain associated with the tectonic stress.

Objects and Advantages: Accurate knowledge of the reservoir architecture is critical for successful extraction of fluid resources from the Earth's crust. It has been found that the Transient Stress Field does not fully reflect the permeability but the Induced Transient stress field does. The LP-PFI method uses the Induced Transient Field and the very weak character of the geo-critical nature of the Earth's brittle crust to reveal a reservoir's connected permeable fracture network. It provides a simple, low-cost method for illuminating the permeability field so that it is visible using seismic emission tomography imaging technology. By doing so it permits more accurate well location with respect to well success and to guide fluid injection and withdrawal activities.

Other objects the methods provided herein address include:
1. Provide Information as input for reservoir modeling
2. Provide a means of guiding the placement of subsequent wells for the purposes of infill and/or development and/or enhanced recovery
3. Provide a means of using the information derived to be used for multidimensional analysis of petrophysical properties including direct 4D measurement of components of the permeability field and structural environments
4. Improve velocity model;
5. Improve interpretation of geophysical surveys whose aim is identifying subsurface behavior of the crust associated with fluid motion
6. Provide independent evidence for paths of fluid motion that may be identified by 4D seismic reflection analysis or other means
7. Provide information on possible hazards to human infrastructure arising from deformation of the Earth's crust associated with fluid extraction and injection.

### Statements Regarding Incorporation by Reference And Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Every device, system, combination of components, or method described or exemplified herein can be used to practice the invention, unless otherwise stated.

Whenever a range is given in the specification, for example, a physical dimension or a time range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein, any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that devices, systems, and methods other than those specifically exemplified can be employed in the practice of the invention without resort to undue experimentation. All art-known functional equivalents, of any such devices and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

TABLE 2
Newberry well 55-29 low pressure Permeable Field Imaging source test

| | tank level | 380 gal/min | large gauge | 6 gal/min | small gauge |
|---|---|---|---|---|---|
| time | (4200 gal) | 75-150 psi | Coarse | 3000 psi | Fine |
| local PST | 52 inches max | hi vol pump | grading | hi pres pump | grading |
| xxxx hrs | inches | On/off | psi | on/off | psi |
| 1015 | | on | 0 | off | not in line |
| 1017 | | on | | off | not in line |
| 1027 | | on | 0 | off | not in line |
| 1029 | | on | | off | |
| 1034 | | on | | off | 78 |
| 1042 | | off | | off | |
| 1044 | | off | | off | |
| 1048 | | on | 70 | off | 78 |
| 1058 | 17.5 | off | | off | |
| 1104 | | | | on | (30-35) |
| 1110 | | | | on | |
| (1145) | ~21 | | | on | |
| 1216 | | | | on | 85 |
| 1225 | 23.3 | | | on | |
| 1230 | | | <100 | on | 90 |
| 1300 | | | | on | 100 |
| 1308 | | | | on | 105 |
| 1311 | | | | on | |
| 1315 | | | | on | |
| 1330 | 26.25 | | >100 | off | (115) |
| 1345 | −143 gal | Flowback | | | NA |

We claim:

1. A method of imaging a connected permeable fracture network of a fluid reservoir in rock, the method comprising the steps of:
establishing a network of seismic sensors centered around at least one fluid injection site in said fluid reservoir for detecting small-amplitude seismic emissions;
injecting a fluid into the at least one fluid injection site, causing a fluid pressure wave to be generated in said fluid reservoir and an increase in fluid pressure in the fluid injection site, wherein the increase in pressure is less than a fracture pressure (P_{frac}), and P_{frac} is a pressure required to induce a new permeable fracture in the connected permeable fracture network and cause a fluid loss from a wellbore into at least one of the induced new permeable fractures;
wherein the increase in fluid pressure is greater than 0 and less than 10 MPa and selected to produce an instantaneous elastic deformation of the rock and stimulate a small-amplitude seismic emissions from the connected permeable fracture network without an earthquake(s) detectable with a surface seismic station associated with said at least one injection site,
acquiring the seismic emission with the network of seismic sensors;
imaging with the network of seismic sensors and at least one volume of the instantaneous elastic deformation comprising the connected permeable fracture network and the at least one fluid injection site, wherein the at least one volume image comprises a temporal migration of the small-amplitude seismic emissions away from said at least one injection site;
identifying from said image of the at least one volume a connected permeable fracture(s) that form said connected permeable fracture network to which said at least one injection site is connected,
thereby imaging said connected permeable fracture network of said fluid reservoir.

2. The method of claim 1, wherein the increase in pressure corresponds to a fluid pressure in the at least one fluid injection site that is a well borehole and that does not form a plurality of new permeable fractures in the connected fracture network.

3. The method of claim 1, further comprising the step of determining the increase in pressure by:
increasing the pressure from a minimal pressure and incrementally increasing the minimal pressure until the connected permeable fracture network is stimulated.

4. The method of claim 1, further comprising the step of using the imaged connected permeable fracture network to:
position a well borehole; and/or
guide injection and withdrawal activities.

5. The method of claim 1, further comprising the step of: using the image of the at least one volume as an input to a model of said fluid reservoir.

6. The method of claim 4, further comprising the step of: using the image of the at least one volume to position additional well boreholes.

7. The method of claim 6, wherein the additional well boreholes are used for infill, development, and/or enhanced recovery of a liquid from the fluid reservoir.

8. The method of claim 1, further comprising the step of:
using the image of the at least one volume to perform a multidimensional analysis of a permeable fracture property of said connected permeable fracture network.

9. The method of claim 8, wherein said permeable fracture property comprises one or more petrophysical properties.

10. The method of claim 8, wherein said multidimensional analysis includes direct time lapse 3D seismic (x,y,z) and 4D seismic (x,y,z,t; where t is calendar time) measurements of components of said connected fracture network over a time period.

11. The method of claim 1, the method further comprising the step of:
using the image of the at least one volume to improve a process, wherein the process is optionally selected from one or more of: a reservoir model, a tiltmeter survey model, a fluid motion model, and/or a hazard model associated with fluid extraction and injection into and out of native rock.

12. The method of claim 11, wherein the step of using the image of the at least one volume to improve said process comprises using the image of the at least one volume to improve a velocity model.

13. The method of claim 11, wherein the step of using the image of the at least one volume to improve said process comprises using the image of the at least one volume to improve interpretation of a geophysical survey.

14. The method of claim 13, further comprising the step of: identifying subsurface behavior of the Earth's crust associated with fluid motion.

15. The method of claim 11, wherein using the image of the at least one volume to improve said process comprises using the image of the at least one volume to confirm paths of fluid motion.

16. The method of claim 11, wherein using the image of the at least one volume to improve said process comprises using the image of the at least one volume to identify and assess risk of possible hazards from deformation of the Earth's crust associated with fluid injection and fluid extraction, the hazard including damage to human infrastructure.

17. The method of claim 1, wherein the imaging comprises identifying and mapping a location of one or more of: a permeable fracture; a permeable fracture network; and/or an interconnected fluid filled void in native rock.

18. The method of claim 17, wherein the imaging is prior to a step of drilling a well borehole and/or guiding fluid injection and fluid recovery from the fluid reservoir.

19. The method of claim 1, wherein the increase in fluid pressure occurs in one or more pre-existing boreholes positioned within the fluid reservoir.

20. The method of claim 1, wherein the network of seismic sensors comprise near and/or near-surface seismic arrays.
